(19) United States
(12) Patent Application Publication
(10) Pub. No.: US 2025/0121489 A1
(43) Pub. Date: Apr. 17, 2025

(54) Gripper Applicator for External Gripping Tool

(71) Applicant: PETRÓLEO BRASILEIRO S.A. - PETROBRAS, Rio de Janeiro (BR)

(72) Inventors: Ney Lima Chagas, Natal (BR); Alex Pinheiro Garcia, Mossoro (BR); Francisco Flavio De Souza Pinheiro, Mossoro (BR); Tony Batista Do Nascimento, Jatoba (BR); Jonathas Micael Fernandes De Melo, Mossoro (BR); Tiago De Lima Duarte, Mossoro (BR)

(73) Assignee: PETRÓLEO BRASILEIRO S.A. - PETROBRAS, Rio de Janeiro (BR)

(21) Appl. No.: 18/914,596

(22) Filed: Oct. 14, 2024

(30) Foreign Application Priority Data
Oct. 17, 2023 (BR) 1020230215629

(51) Int. Cl. B25J 1/02

(52) U.S. Cl. CPC B25J 1/02

(57) ABSTRACT

The present invention relates to a device or tool called a basket-type gripper applicator on the external gripping tool that can be used in several fishing operations on oil platforms, whenever it is necessary to assemble or disassemble a basket-type gripper on the external gripping tool. As an improvement point, the prototype of the gripper applicator will have the insertion of a handwheel for handling, in addition, the gripper applicator can be used on all existing overshot diameters, both in the 70 series and in the 150 series, for the insertion of basket-type grippers. The main components of the invention are the pin, arm, washer, handle, spring, nut and screw.

### CROSS-REFERENCE TO RELATED APPLICATIONS

This application claims priority to Brazilian Application No. BR1020230215629 filed on Oct. 17, 2023, the disclosure of which is expressly incorporated herein by reference in its entirety.

### FIELD OF THE INVENTION

The present invention is part of the technical field of oil and gas, more specifically related to vessels, platforms, rigs and production facilities, and also related to drilling and completion of wells, referring to a gripper applicator device to insert it into the overshot or external gripping tool.

### BACKGROUND OF THE INVENTION

The overshot (or external gripping tool) is a fishing tool used for external gripping of drilling and production pipes, packers, mandrels, as well as any tubular bodies that fall within the gripping range of the tool. The object to be gripped is known in the fishing activity as a “fish”.

The overshot is formed by a cylindrical body, a sub-top, gripper and gripper control. One of the two most commonly used types of overshot are the 70 and 150 series. The body of the overshot has a spiral section inside. The gripper, which is the gripping member, is inserted inside the body of the overshot, adjusting to the spiral section. The grippers can be of two types: spiral and basket.

The gripping is done by a gripper inserted inside the overshot, which fits into a helical thread. The overshot, depending on its diameter and model, accommodates a specific range of grippers. For example, the 150 series overshot, with an external diameter of 5¾″, has a maximum value of 4¾″, for a spiral type gripper, and 4¼″, for a basket type gripper, also known as a basket.

The existing overshots can have an external diameter of 3⅝″ to 11¾″, and from 4⅛″ to 15″, for the 150 and 70 series, respectively. The range of diameters of the grippers that can be allocated to these overshots will vary, among other parameters, by the external diameter of the overshot.

Regarding the types of grippers, the spiral gripper is a left-hand helix with the exterior facing the overshot. The basket gripper is shaped like a cylinder with a conical exterior to accommodate the conical helical section of the overshot. The interior of the basket gripper is formed by wavy and sharp suctions, which, when they encase the fish, complete the grip.

It is noted that, many times, there is some difficulty in assembling and disassembling the gripper in the overshot. Until then, there is no tool for assembling and disassembling the gripper in the overshot. The gripper is inserted into the overshot by placing the hand inside the gripper and making it turn. Sometimes, due to the type of gripper or overshot, it is not possible to insert the hand inside it.

The process commonly carried out for inserting a basket gripper in the overshot consists of: inserting the hand inside the gripper; positioning it inside the overshot and turning it counterclockwise. To remove the gripper, simply turn it clockwise. This process of inserting the hand inside the gripper to make it run inside the overshot can be difficult, especially in smaller diameter grippers, due to the greater difficulty and even impossibility of inserting the hand inside them.

In view of the above, in order to solve the technical problem reported above, the present invention develops a device or tool for applying a gripper. With the applicator, it is possible to grip the internal gripper and insert it into the overshot, regardless of its diameter.

In addition, the gripper applicator provides cleaner and safer work, since it prevents the hands of the operator from coming into contact with the internal surface of the gripper—which is sharp—and also with the grease that is commonly applied to the inside of the overshots. Thus, the main application of the tool is to assist in fishing operations in oil wells and, also, in the maintenance of the overshots.

### State of the Art

Document U.S. Pat. No. 7,096,952 B2 is part of the general state of the art and describes a guide for the locking mechanism that is applied in the field of tools used to recover lodged or trapped items, called fish, from a wellbore or casing. However, it should be noted that equipment is protected to guide the fish and grab it by a locking mechanism, while the gripper applicator of the present invention is not considered a fishing tool per se, and does not have the function of gripping, fishing and recovering tubes, packers or any elements from the well. The function of the gripper applicator is to assist in the insertion or removal of the basket-type gripper inside the overshot, facilitating the assembly or disassembly of the overshot on the surface.

In its turn, document BR 1120120110659 is also part of the general state of the art and proposes a gripper, spiral gripper, large-catch vertical lifting tool (overshot) and their uses, used in fishing operations and, more particularly, modifications to grippers, controls and cups to enable the fitting of a larger range of lost object. In this way, it differs from the proposal of the present invention, since it is an overshot optimized for gripping structures and does not resemble the gripper applicator as much. The gripper applicator is not considered a fishing tool, as it does not enter the well. It is applied on the surface, assisting in the insertion and removal of the basket gripper from the overshot.

Document U.S. Pat. No. 4,004,835 A, which is also part of the general state of the art, proposes an improved overshot having an upper body and a fixed internal tubular sleeve for gripping a fishing neck that has a lowered shoulder with a protruding widening. Although the aforementioned document shows an invention that comprises a shape similar to a pair of scissors for gripping, such equipment is intended for fishing to recover fish that are inside the well, which is not so similar to the gripper applicator, as its function is to insert or remove the basket gripper from inside the overshot. It is the overshot that is a fishing tool, intended to descend into the well to recover tubular elements, and does not have the same field of application as the gripper applicator.

Document U.S. Pat. No. 9,022,440 B2 protects a fishing guide for directing a fish at an angle in a well bore, the guide has an open end and a finger structure, in addition, the guide is executed in a small diameter configuration through a restriction with a fishing tool, such as an overshot, above it. However, it is noted that the referred invention concerns a fishing guide for directing a fish at an angle in the well bore, a tool that is lowered into the well for the purpose of guiding the gripping. The gripper applicator does not go down into the well, not being considered a fishing tool exactly, but rather a tool used on the surface, in the handling of one of the overshot accessories, the gripper.

Finally, document U.S. Pat. No. 6,425,615 B1, despite also being part of the general state of the art, comprises an overshot with a radially expandable and contractible gripper, not to be confused with and resembling the gripper applicator of the present invention, which has the function of preparing the overshot for its descent into the well, with the insertion of the basket-type gripper or assisting in the disassembly of the overshot, already on the surface, with the removal of the gripper.

Thus, considering the above, it is noted that in the state of the art there is no tool or device like the gripper applicator of the present invention, which is equipment designed to facilitate the assembly and disassembly of the basket-type gripper in overshots, as well as to increase safety in this activity. The moment of use of the gripper applicator occurs during the assembly and disassembly of the overshot, at the time when the gripper is inserted or removed.

### SUMMARY

The present invention relates to a device or tool called a basket-type gripper applicator on the overshot that can be used in several fishing operations on oil platforms, whenever it is necessary to assemble or disassemble a basket-type gripper on the overshot. The prototype of the gripper applicator has a handwheel for handling and can be used on all existing overshot diameters, both 70 series and 150 series, for the insertion of basket-type grippers. The main components of the invention are a pin, arm, washer, handle, spring, nut and screw.

### BRIEF DESCRIPTION OF THE FIGURES

In order to obtain a total and complete visualization of the object of this invention, the figures to which references are made below are presented.

FIG. 1 schematically represents the overshot gripper applicator, highlighting its main components and parts, according to a preferred embodiment of the invention.

FIG. 2 schematically represents in more detail the particularities of the arms of the overshot gripper applicator and their angles, according to a preferred embodiment of the invention.

FIG. 3 schematically represents the handle of the overshot gripper applicator, highlighting the cross-knurled part and its shape, according to a preferred embodiment of the invention.

FIG. 4 schematically represents the pin used in the overshot gripper applicator, highlighting its shape and angles, according to a preferred embodiment of the invention.

FIG. 5 schematically represents photographs of how to proceed to use the overshot gripper applicator, according to a preferred embodiment of the invention.

### DETAILED DESCRIPTION OF THE INVENTION

The present invention shows a device or tool called a basket-type gripper on the overshot, which can be used in several fishing operations on oil platforms whenever it is necessary to assemble or disassemble a basket-type gripper on the overshot.

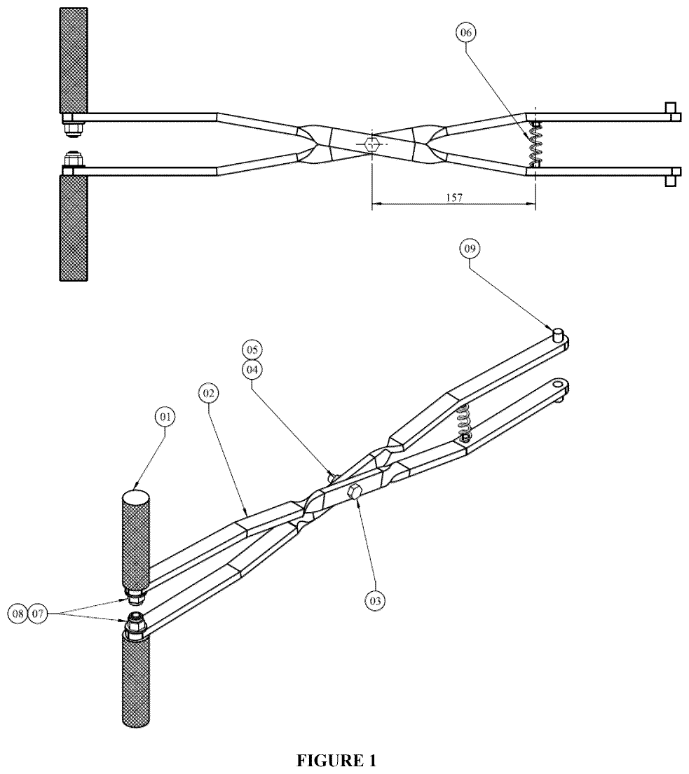

According to FIG. 1, the gripper is composed of at least two handles (1), at least two arms (2), at least one screw (3), at least two nuts (4), at least two washers (5), at least one spring (6), at least one nut (7), at least one washer (8), at least two pins (9).

The spring (6) can be manufactured from spring steel, have an external diameter of 20 mm, a wire diameter of 2.5 mm, a free length of 80 mm and a square end. The screw (3) can be a 5/16″-UNCx 1.1/4″ hexagonal screw and can be made of AISI B18.2.1 steel.

The nut (4) can be a 5/16″-UNC self-locking nut and can be made of SAE J995 GRADE 2 steel. The washer (5) can be a Ø 5/16″ plain washer and can be made of AISI B18.22.1 steel.

The nut (7) can be a ⅜″-UNC self-locking nut and can be made of SAE J995 GRADE 2 steel. The washer (8) can be a Ø ⅜″ plain washer and can be made of AISI B18.22.1 steel.

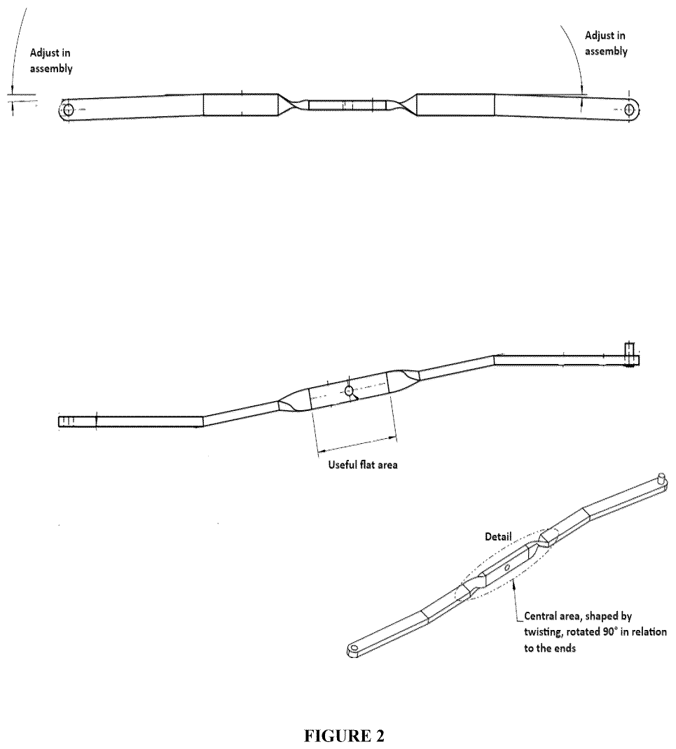

According to FIG. 2, the arms comprise a central area, shaped by twisting and rotated 90° in relation to the ends, in addition, within the central area there is a useful flat area. The arms (2) may comprise a length of 590 mm and a thickness of 5/16″, in addition, they comprise a central hole with a diameter of Ø 8 mm in the useful flat area.

Also according to FIG. 2, the arms (2) comprise holes at the ends that may have a radius of 9 mm, in which pins (9) are inserted at one of these ends, preferably the right end, and the handle (1) is inserted at the other end, preferably the left end.

In this way, the handle (1) is screwed into the upper part of each arm (2) by means of a nut (7) and washer (8). In which the pins (9) are attached to the lower part of the arms (2).

The arms (2) of the gripper applicator are joined by means of a screw (3), a nut (4) and a washer (5). A spring (5) is placed between the lower parts of the arms (2).

The handle (1) is the fishing point of contact of the operator with the gripper applicator, allowing the upper part of the arms (2) to be tightened to adjust the lower part to the inside of the gripper, and also allowing the applicator to be rotated to screw the gripper into the overshot

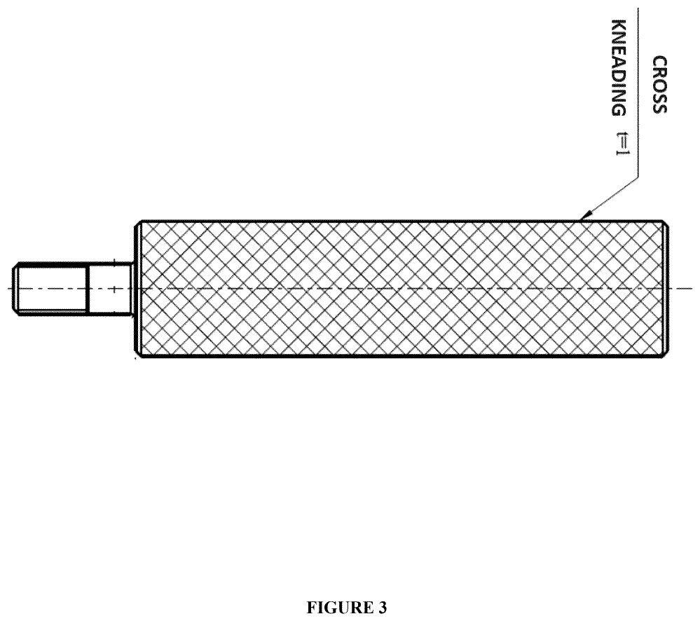

As shown in FIG. 3, the handle (1) can be manufactured from SAE 4140 steel and has a cylindrical shape and an external surface with a knurled/cross-stitched finish. The handle (1) comprises a larger cylinder 100 mm long and with a diameter of Ø 25.4 mm, at the left end, concentric with the upper phase of the larger cylinder, a smaller cylinder 23 mm long and with a diameter of Ø 9.5 mm is positioned.

The smaller cylinder is used to make the coupling and screwing in the upper part of each arm (2) by means of a nut (7) and washer (8).

The arms (2) comprise a main body manufactured in a single piece, shaped by torsion and are responsible for making the articulation between the handles (2) and the pins (9). The spring (6) has the function of keeping the lower part of the arms (2) open, only closing when force is applied to the upper part, through the handle (1).

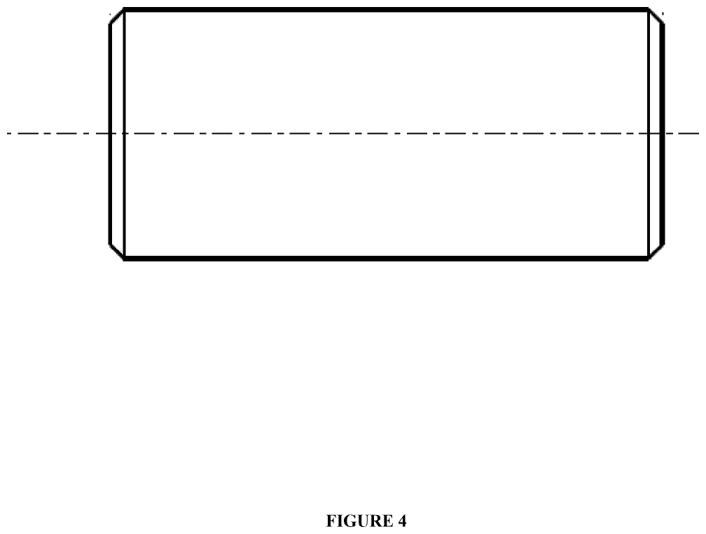

As shown in FIG. 4, the pins (9) fit into the holes of the gripper, allowing rotation to be transmitted. The pins (9) are cylindrical in shape, can be manufactured in SAE 4140 steel, and can be 20 mm long and Ø 9.0 mm in diameter.

Before the design of the gripper applicator of the present invention, the insertion of the gripper into the overshot is done by inserting the hand of the operator inside the gripper, making it rotate counterclockwise so that the exterior of the conical cylinder gripper can accommodate the helical conical section of the overshot.

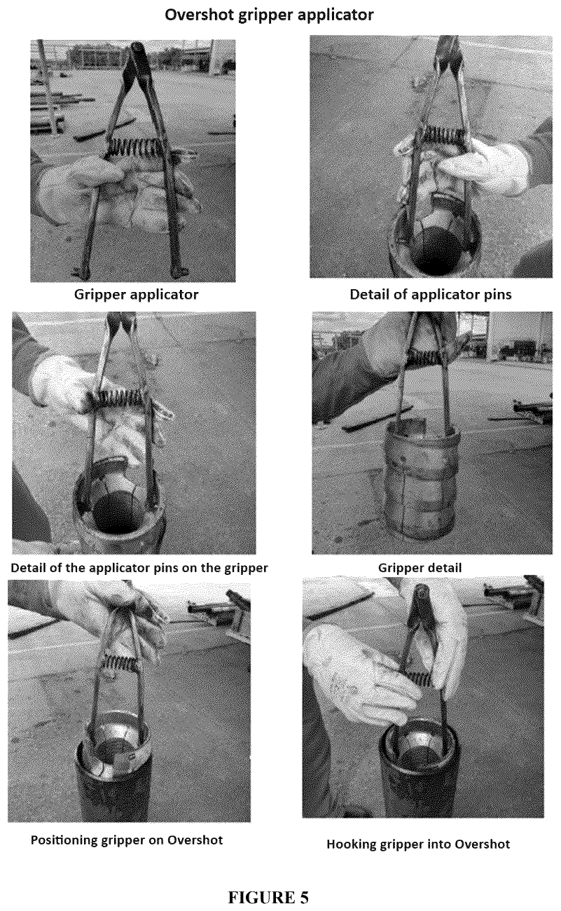

However, as shown in FIG. 5, with the use of the gripper applicator, instead of inserting the hand inside the gripper, the gripper applicator is connected to the inside of the gripper by means of pins (9) that are housed there.

By handling the gripper applicator handle (2), the operator can both adjust the applicator to the diameter of the gripper and apply rotation so that the gripper enters the overshot. In this way, the gripper applicator completely eliminates the need to insert the hand inside the gripper.

It is important to highlight that the gripper applicator can be used on all overshot diameters that exist in the state of the art, including the most commonly used ones, both in the 70 series and in the 150 series, for inserting basket-type grippers.

The gripper applicator is used by both fishing operators and mechanics in maintenance activities. It was found that a) the gripper applicator prevents the conical thread of the basket gripper from overlapping the thread of the overshot; b) the fishing operator, when placing the gripper on the overshot, no longer needs to insert his hand inside the gripper, thus avoiding a possible incised injury to the hand by means of a sharp object, since the internal threads of the gripper are sharp.

In addition, c) the gripper applicator prevents the hand of the operator from coming into contact with the inside of the overshot, preventing possible hydrocarbon poisoning; d) the gripper applicator assists maintenance in removing the gripper, which, because it is subject to dirt resulting from grease, sand and ferrous material coming from the well, can get stuck in the overshot.

Finally, with the gripper applicator, the operator can apply greater force to remove it. In addition, it keeps the hands free from possible contamination by hydrocarbons and other agents coming from the well.

In view of the above, it is noted that the present invention is characterized by economic and productivity advantages, as it results in greater agility in the assembly and disassembly of the gripper, implying a shorter operating time.

As well as advantages related to health and safety, since it minimizes the chances of the operator injuring his hands, as it prevents them from coming into contact with the internal surface of the gripper.

Those skilled in the art will value the knowledge showed herein and will be able to reproduce the invention in the modalities showed and in other variants, covered by the scope of the attached claims.

1. GRIPPER APPLICATOR FOR EXTERNAL GRIPPING TOOL, comprising at least two handles, at least two arms, at least one screw, at least two nuts, at least two washers, at least one spring, at least one nut, at least one washer, at least two pins.

2. GRIPPER APPLICATOR, according to claim 1, wherein the gripper is of the basket type.

3. GRIPPER APPLICATOR, according to claim 2, wherein the handle is screwed into the upper part of each arm by means of a nut and washer.

4. GRIPPER APPLICATOR, according to claim 3, wherein the pins are affixed to the lower part of the arms.

5. GRIPPER APPLICATOR, according to claim 4, wherein the arms of the gripper are joined by means of a screw, a nut and a washer.

6. GRIPPER APPLICATOR, according to claim 5, wherein the spring is arranged between the lower parts of the arms.

7. GRIPPER APPLICATOR, according to claim 6, wherein the handle is the point of contact between the fishing operator and the gripper applicator, allowing the upper part of the arms to be tightened to adjust the lower part to the inside of the gripper.

8. GRIPPER APPLICATOR, according to claim 7, wherein the handle allows the applicator to be turned to screw the gripper into the overshot.

9. GRIPPER APPLICATOR, according to claim 8, wherein the arms comprise a central area shaped by twisting and rotated 90° in relation to the ends.

10. GRIPPER APPLICATOR, according to claim 9, wherein the arms comprise a useful flat area located within the central area.
